(19) United States
(12) Patent Application Publication
(10) Pub. No.: US 2024/0369398 A1
(43) Pub. Date: Nov. 7, 2024

(54) SMART NURSING PILLOW

(71) Applicant: Nechama SILBERBERG, Brooklyn, NY (US)

(72) Inventor: Nechama SILBERBERG, Brooklyn, NY (US)

(21) Appl. No.: 18/256,418

(22) PCT Filed: Jan. 4, 2023
(86) PCT No.: PCT/US2023/060092

§ 371 Date: Jun. 7, 2023

Related U.S. Application Data
(60) Provisional application No. 63/312,767, filed on Feb. 22, 2022.

(51) Int. Cl. G01G 19/44; A47D 13/08; G01G 21/22; G01G 23/14; G01G 23/18

(52) U.S. Cl. CPC G01G 19/445; A47D 13/083; G01G 21/22; G01G 23/14; G01G 23/18

(57) ABSTRACT

A smart nursing pillow including a scale having a top rigid platform operatively attached to a top side and a top pillow portion operatively attached to the top rigid platform, and an air gap between a bottom side of the scale and a bottom rigid platform. A mobile application for use with the smart nursing pillow including an onboarding module, a home screen module, a Record a Feed module, a Feeding Dashboard, a Growing Dashboard, a Tutorial/Content Dashboard, and a Smart Nursing Pillow Device Dashboard stored on non-transitory computer readable media. A method of using the application. A method of using the smart nursing pillow, by placing a baby on the top pillow portion, weighing the baby before a feeding session with the scale, feeding the baby, and weighing the baby after the feeding session with the scale. A method of weighing a baby.

### BACKGROUND OF THE INVENTION

### 1. Technical Field

The present invention relates to compositions and methods for measuring weight and food intake of an individual or animal. More specifically, the invention relates to a scale embedded between soft materials that can measure weight and food intake.

### 2. Background Art

Nursing pillows are useful in allowing a baby to rest and be supported while breastfeeding. Some pillows are simple and others contain various features such as storage or weighing devices.

U.S. Pat. No. 7,657,955 to Alvistur, et al. discloses a nursing pillow with integrated privacy panels that provide privacy to mothers while breast feeding infants. The pillow is U-shaped having a soft filler material and a pillowcase. A neck strap helps keep the pillow close to the mother. The infant is supported on the pillow and kept near the mother's body. The pillow folds in on itself for ease of transport and storage.

U.S. patent application No. 20110179575 to Mastrosimone-Gese discloses a nursing pillow that includes a body with a first end, a medial portion, and a second end. The pillow possesses a generally C-shaped structure defining an interior well operable to curve around a body part of a user. The interior of the pillow body defines a cavity, which may include a series of cells containing a predetermined amount of fill material. The ends of the pillow body may include fasteners that connect to draw the ends of the pillow together, forming a compact support surface. The pillow also includes an internal compartment for storing articles such as blankets, bottles, etc.

U.S. Pat. No. 8,927,883 to Roth discloses an infant-nursing platform that includes a cushion adapted for supporting a baby while nursing. The cushion has a support surface. Weighing means are disposed within the cushion and operably coupled to the support surface to weigh the baby on the support surface of the cushion. A user interface device is operably coupled to the weighing means to obtain measurement information therefrom. The user interface device produces an output in response to the measurement information obtained from the weighing means. This device only provides the weight of the baby and does not provide any other metrics that can be important in the analysis of a feeding session. There is also no proof that a scale disposed within the Roth patent actually works and is accurate.

There remains a need for a nursing pillow that is able to accurately record data about the feeding session.

### SUMMARY OF THE INVENTION

The present invention provides for a smart nursing pillow including a scale having a top rigid platform operatively attached to a top side and a top pillow portion operatively attached to the top rigid platform, an air gap between a bottom side of the scale and a bottom rigid platform, and optionally, a bottom pillow portion operatively attached to the bottom rigid platform.

The present invention provides for a mobile application (“app”) for use with the smart nursing pillow including an onboarding module, a home screen module, a Record a Feed module, a Feeding Dashboard, a Growing Dashboard, a Tutorial/Content Dashboard, and a Smart Nursing Pillow Device Dashboard stored on non-transitory computer readable media.

The present invention provides for a method of using the app, by a user accessing the onboarding module and creating a profile and adding baby details, accessing a home screen module and reviewing quick stats, accessing a Record a Feed module and entering or recording a feed, accessing a Feeding Dashboard and accessing a feeding log, accessing a Growing Dashboard and accessing a weight log, accessing a Tutorial/Content Dashboard for questions and answers, and accessing a Smart Nursing Pillow Device Dashboard and reviewing smart nursing pillow device details.

The present invention provides for a method of using the smart nursing pillow, by placing a baby on the top pillow portion, weighing the baby before a feeding session with the scale, feeding the baby, and weighing the baby after the feeding session with the scale.

The present invention provides for a method of weighing a baby, by placing the baby on the smart nursing pillow, and weighing the baby.

The present invention provides for a scale for weighing an individual, including a top rigid platform and a bottom rigid platform surrounding the scale such that an air gap is provided between a bottom side of the scale and the bottom rigid platform, and a top pillow portion operatively attached to the top rigid platform.

### DESCRIPTION OF THE DRAWINGS

Other advantages of the present invention are readily appreciated as the same becomes better understood by reference to the following detailed description when considered in connection with the accompanying drawings wherein:

FIG. 1 is a top perspective view of a smart nursing pillow;

FIG. 2 is a side view of the smart nursing pillow;

FIG. 3 is an exploded view of the smart nursing pillow;

FIG. 4 is a side view of the smart nursing pillow with an infant insert;

FIG. 5 is a side view with a partial cut-away;

FIG. 6A is a partial side view showing an air gap, and FIG. 6B is a partial side view showing fabric covering the air gap;

FIG. 7 is an exploded view showing a scale;

FIG. 8A is a side perspective view showing a pocket, and FIG. 8B is a side perspective view showing an illumination mechanism;

FIG. 9A is a side view of a strap, FIG. 9B is a perspective view of a strap, and FIG. 9C is a perspective view of a strap with the smart nursing pillow;

FIG. 10A shows hardware controls, FIG. 10B shows hardware controls, FIG. 10C shows hardware controls and the illumination mechanism, and FIG. 10D shows hardware controls;

FIG. 11 is a diagram of flow of information in an application; and

FIG. 12 is a screenshot of the application.

### DETAILED DESCRIPTION OF THE INVENTION

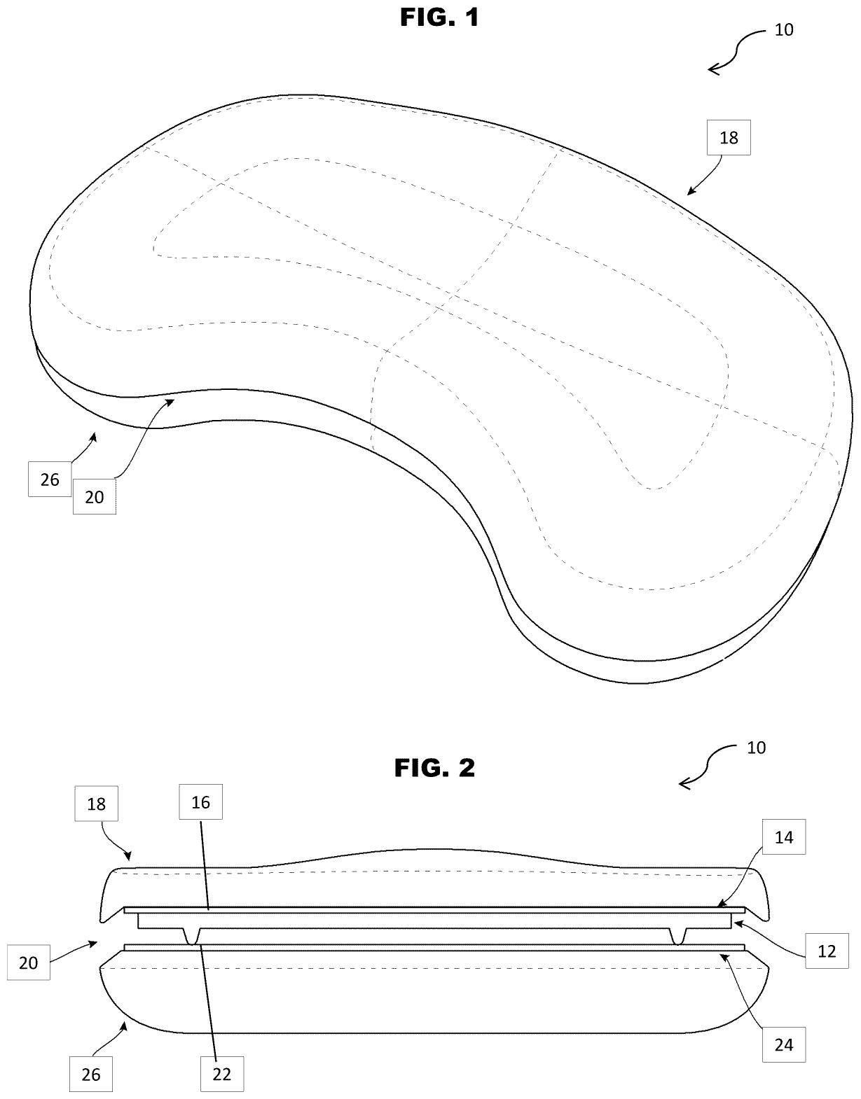

The present invention is generally directed to a smart nursing pillow 10, shown in FIG. 1, that can record various statistics about an individual (human or animal, and preferably a baby) during its use regarding feeding, such as with breastmilk or formula. It should be understood that while a baby is referred to throughout, this can also mean any individual human or animal.

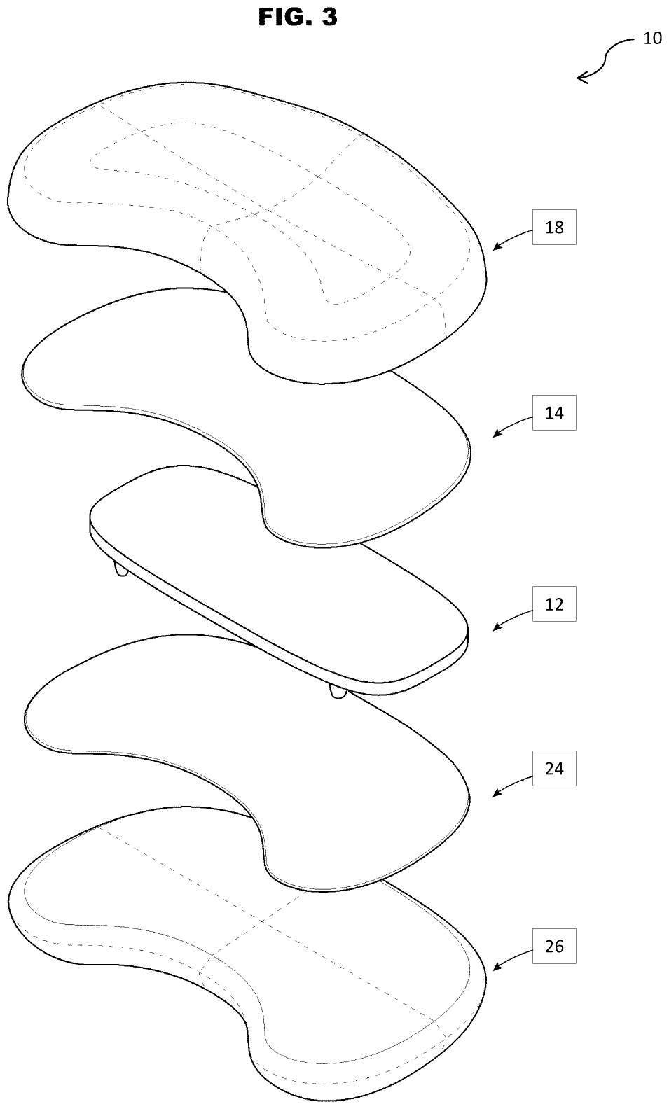

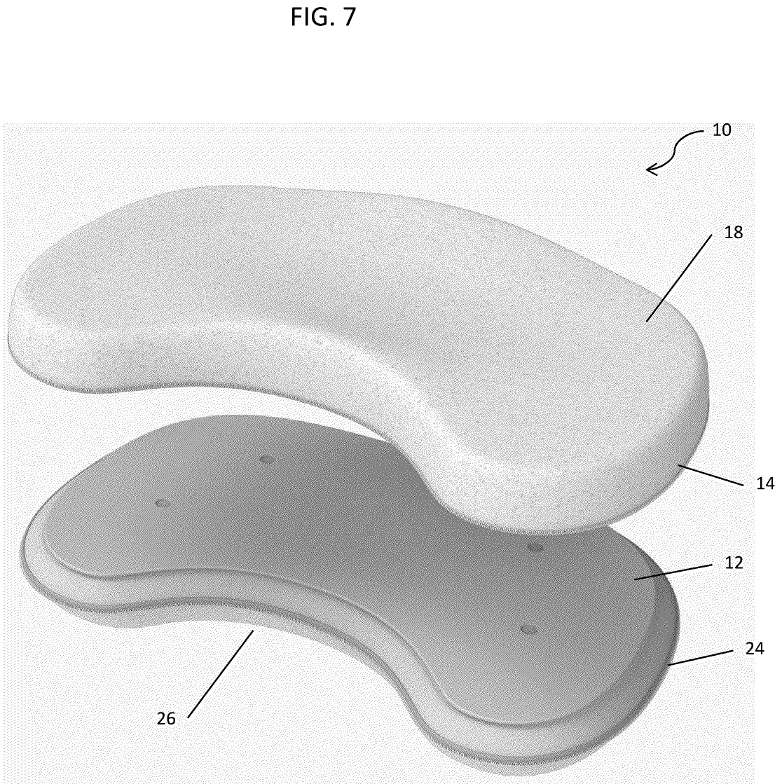

Most generally, the smart nursing pillow 10 includes a scale 12 embedded within a soft material such as a cushion or pillow as further describe below. As shown in FIGS. 2, 3, and 7 the smart nursing pillow 10 includes a scale 12 having a top rigid platform 14 operatively attached to a top side 16 of the scale 12 and a top pillow portion 18 operatively attached to the top rigid platform 14, an air gap 20 between a bottom side 22 of the scale 12 and a bottom rigid platform 24, and optionally, a bottom pillow portion 26 operatively attached to the bottom rigid platform 24. The smart nursing pillow 10 essentially uses a sandwich construction in which there is a scale 12, or scale sensors, placed between two rigid platforms (an upper 14 and a lower 24) with an air gap 20 between them. Outside of these two rigid platforms 14, 24 there can be a soft upper cushion/pillow 18 and a soft lower cushion/pillow 26. The enforced air gap 20 is key to the function of the smart nursing pillow 10 as accuracy is only maintained because the air gap 20 between the platforms 14, 24 ensures the scale 12 only measures weight above the upper platform 14. None of the weight above the scale 12 is supported by the lower platform 24 because of this air gap 20, which means the scale 12 accurately measures the entire weight above it.

The smart nursing pillow 10 is preferably in a C shape for ease of use of a mother in feeding a baby, but other shapes can be used such as a rectangle, square, or circle for other uses.

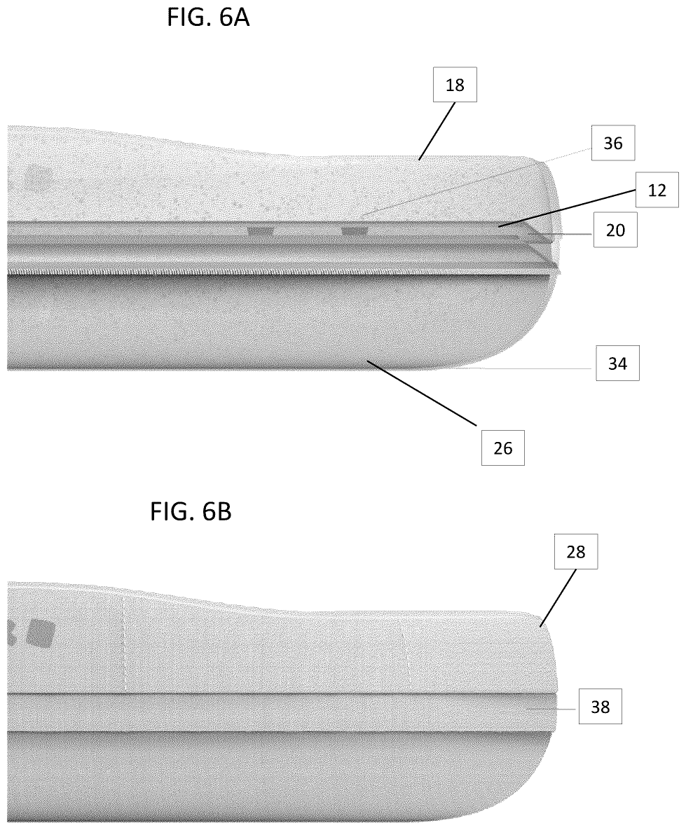

The scale 12 can tare, or zero out, the weight of the components of the smart nursing pillow 10, so that just the baby's weight is precisely measured. Preferably, the scale 12 is digital. Accuracy of the scale 12 is maintained because between the top rigid platform 14 and the bottom rigid platform 24 is an air gap 20. The air gap 20 ensures that the scale 12 with feet 36 only measures the weight above the top rigid platform 14 (shown in FIG. 6A). The feet 36 generally include sensors that accurately detect weight. The air gap 20 is always maintained. None of the weight above the scale 12 is supported by the bottom rigid platform 24 because of this air gap 20. In other words, the scale 12 detects the entire weight above the scale 12 but not any weight below. If the top rigid platform 14 or bottom rigid platform 24 were not rigid, it is possible that they could deform or give and touch the scale 12 or weight would not be distributed evenly across the scale 12. This would mean that the weight would bypass the sensors in feet 36 that detect the weight of the baby and the weight would not be accurate. By maintaining an air gap 20, it is ensured that the weight measured is accurately on the scale 12. The reason the air gap 20 works, is that the scale 12 is able to tare, or zero out, the top pillow portion 18 on top of it and retain stability related to the bottom pillow portion 26 underneath it. The smart nursing pillow 10 is essentially a scale 12 in between two cushions, designed in a fashion to disregard the two cushions' weights and instabilities. This is analogous to a bathroom scale on a hard floor versus a carpeted floor. If the scale is on a soft carpeted floor instead of a hard floor, the weight is not distributed evenly and the weight captured by the sensors is incorrect. It is difficult and unproven for prior art nursing scales, such as the platform in U.S. Pat. No. 8,927,883 to Roth, to provide an accurate weight without such an air gap using both a soft upper and soft lower surface to provide comfort both to a baby and mother, as weight sensors distributed within cushions, or any compressible material, without a hard platform immediately underneath the sensors will encounter accuracy issues due to the soft material absorbing and supporting the sensors and scale base. Given the accuracy necessary to measure the tiny amount of breastmilk drank by an infant, even the tiniest percentage of sensitivity impacted by a compressible material immediately beneath the sensors will render the product unfit for use. The design of the present invention is able to provide an accurate weight due to the air gap 20 maintained within the smart nursing pillow 10.

The top rigid platform 14 and bottom rigid platform 24 can be made of the same or different materials and can be made of any hard plastic (acrylonitrile butadiene styrene (ABS), polycarbonate (PC), polystyrene (PS), polyoxymethylene (POM), ABS and PC, polyvinyl chloride (PVC), or polyethylene terephthalate (PET)), or metal (such as aluminum, stainless steel, brass alloy), or glass, or combinations thereof. Essentially, it is desired that the top rigid platform 14 and bottom rigid platform 24 are sturdy but also lightweight.

The top pillow portion 18 and the bottom pillow portion 26 can be made of the same or different materials and can be made of soft synthetic materials (such as foam (polyurethane memory foam, shredded memory foam, shredded foam) or synthetic down), down/feather, Styrofoam, ethylene-vinyl acetate (EVA), synthetic cotton, or cotton. The top pillow portion 18 can also be firmer than the bottom pillow portion 26 to support the mother's arm and increase control and stability. Corners 32 can be rounded for more comfort on the bottom pillow portion 26 or sharper for allowing more space for the baby on the top pillow portion 18 as shown in FIG. 5. The top pillow portion 18 can be concave to securely hold a baby. The bottom pillow portion 26 preferably has a flat bottom surface 34 to avoid tilts. Overall, the dimensions of the smart nursing pillow 10 can be 27 inches by 15 inches by 6 inches, but it can be sized to fit smaller or larger babies as well as animals.

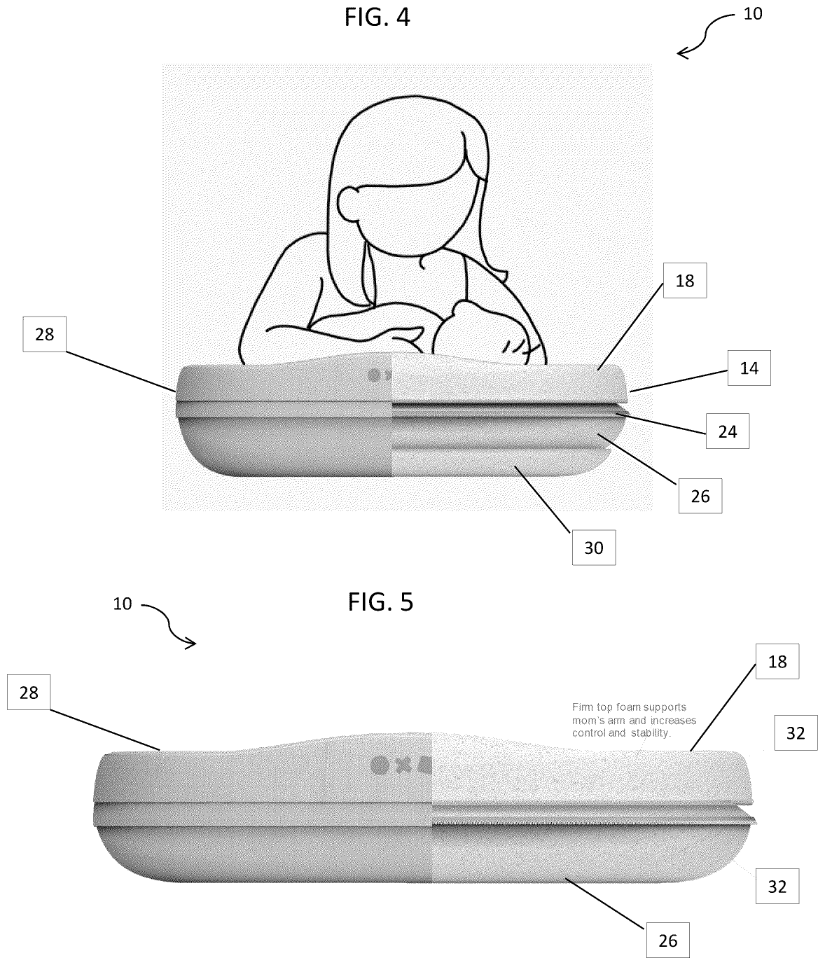

The smart nursing pillow 10 can include an outer cover 28 (shown in FIGS. 4, 5, and 6A) that can be made of fabric and can be removable for cleaning. The outer cover 28 can be made in different colors or patterns. The outer cover 28 can include a lip 38 to cover the air gap 20 (FIG. 6B).

An infant insert 30 can be attached to the smart nursing pillow 10 for a newborn's first weeks as shown in FIG. 4. The infant insert 30, can be placed beneath the bottom pillow portion 26 to enable it to rest higher on the mother's lap and provide more support for an infant that has no head control. Once the baby gets older and has head control, the baby can sit lower on the smart nursing pillow 10 and the infant insert 30 can be removed. FIG. 4 also shows placement of a baby on the smart nursing pillow 10.

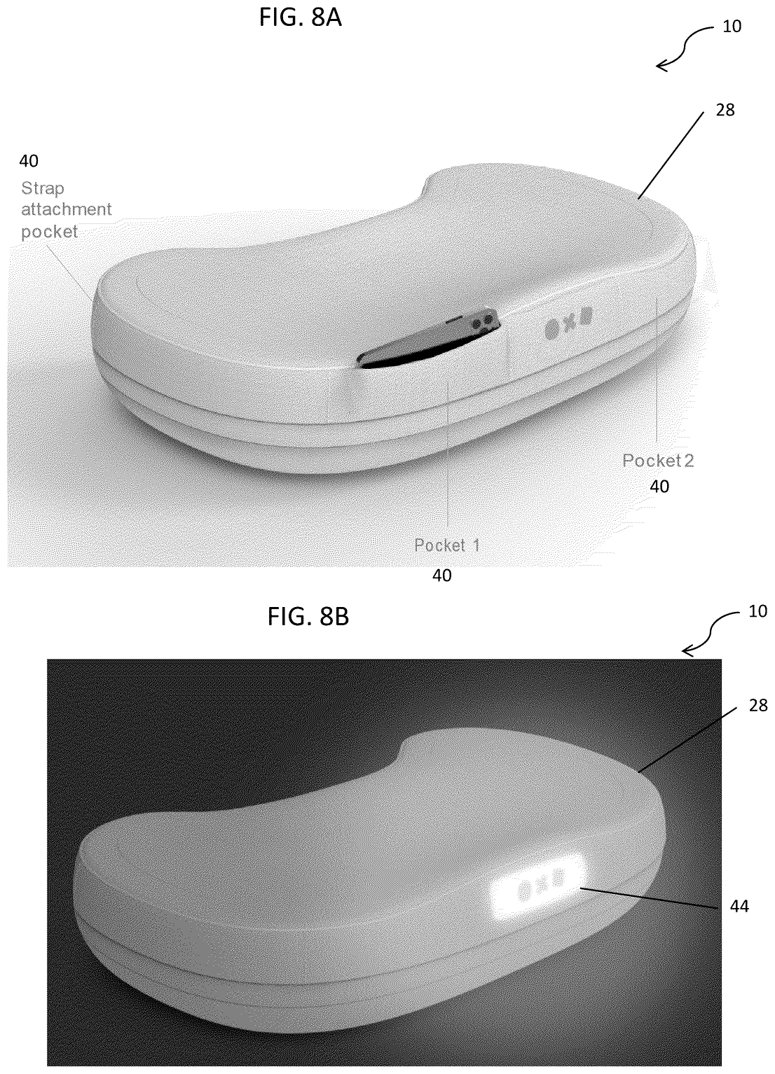

The smart nursing pillow 10 can further include at least one pocket 40 in the outer cover 28 in any suitable location, shown in FIG. 8A for storage or for accessing a strap attachment 42.

The smart nursing pillow 10 can include an illumination mechanism (such as a light fixture) 44 in any suitable location such as on the top pillow portion 18, shown in FIG. 8B. The illumination mechanism 44 can be viewable through the outer cover 28 or the outer cover 28 can be cut away in the area of the illumination mechanism 44. The illumination mechanism 44 is useful for middle of the night feedings or feedings in a dark room. The illumination mechanism 44 can include dimming control.

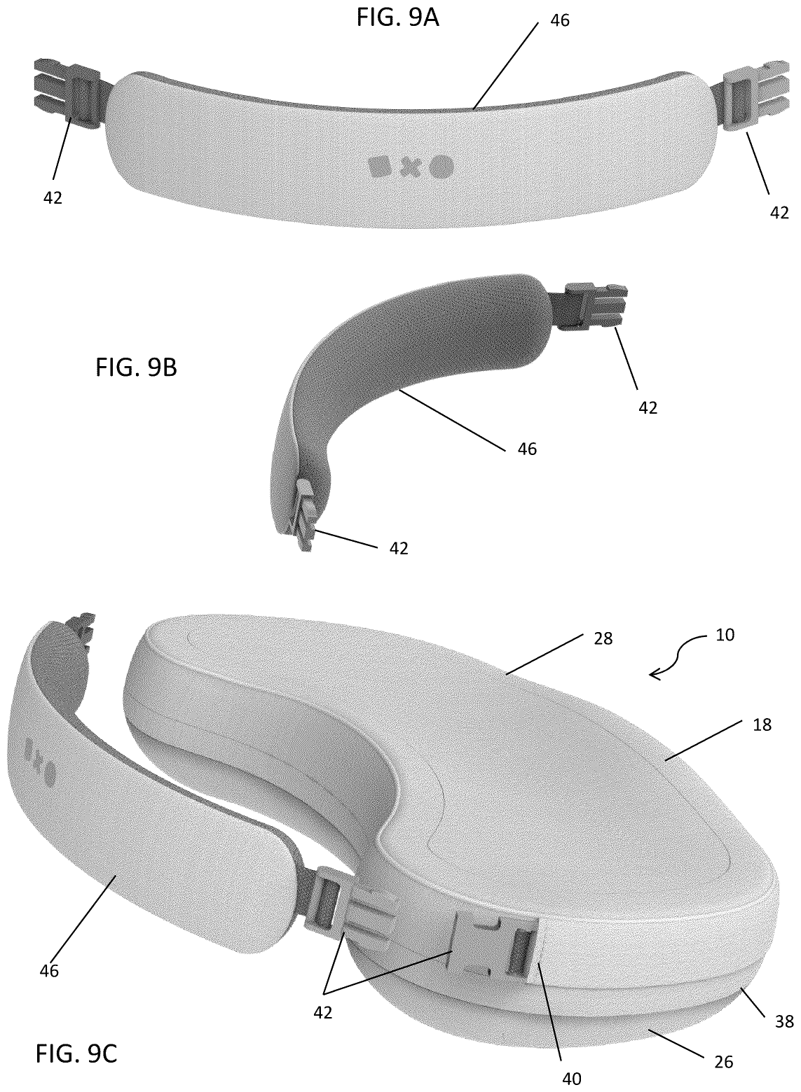

A back strap 46 can be removably attached to the smart nursing pillow 10 through a strap attachment 42 as shown in FIGS. 9A-9C. The back strap 46 allows the smart nursing pillow 10 to be securely attached to a mother while feeding a baby. The back strap 46 can be made of any suitable materials, such as material matching the outer cover 28 and can include padding for comfort. The strap attachment 42 can be releasable buckles, hook and loop, or other attachment mechanisms with corresponding strap attachments 42 on both the back strap 46 and the smart nursing pillow 10.

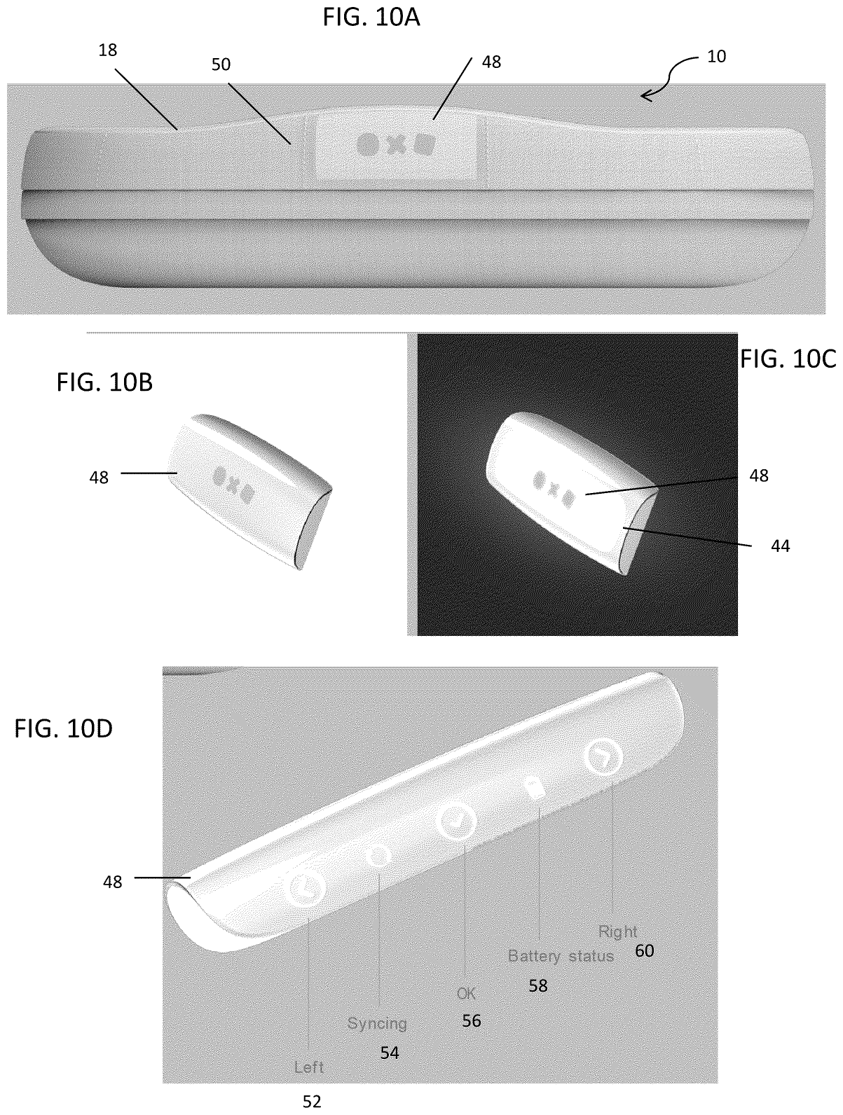

The smart nursing pillow 10 includes any necessary electronics and hardware to function, such as a battery (replaceable or rechargeable, lithium battery, LiFePo4 battery, Li-ion battery, AA battery, AAA battery, or CR2032 battery), hardware for BLUETOOTH® (antenna (monopole or dipole), BLE module, infrared (IR) transmitter, WI-FI, or other wireless transmission, computer storage, circuits (main circuit board including integrated circuit (IC) and amplifier), weight measurement system (×4 load cell, ×2 load cell, ×1 load cell), strain gauge and Wheatstone bridge system, and a display panel 48 (such as an liquid-crystal display (LCD), twisted nematic (TN), organic light emitting diode (OLED), in-plane switching (IPS), or light-emitting diode (LED) screen) shown in FIGS. 10A-10D.

The display panel 48 can be located any suitable place, such as on a front side 50 of the top pillow portion 18 and can be analog or digital. The display panel 48 can be lit by the illumination mechanism 44 or be separate from illumination mechanism 44. The display panel 48 can include indicators and/or buttons for left breast 52, syncing 54, OK 56, battery status 58, and right breast 60, as well as stop and scale. One button can perform multiple functions, such as OK, stop, and scale. The display panel 48 can include a timer for both the left and the right side, so the mother can record the amount of time nursing on the smart nursing pillow 10. The display panel 48 can show the baby weight before the baby is fed and the baby weight at any increment of time during the feeding, so the amount of breast milk/formula the baby has eaten can be extrapolated. When the smart nursing pillow 10 is turned on, the display panel 48 can show how long it has been since the baby last fed and can indicate which side the mother finished feeding on at her last feeding session (as well as indicating which side to start feeding), the total duration of the last feeding session, the duration of feed per side, or combinations thereof. The digital panel 48 can also show an error message to indicate an issue with the scale or other functions (including syncing) of the smart pillow 10.

The smart nursing pillow 10 can collect, measure, and optionally record various information on non-transitory computer readable media during use such as, but not limited to, the weight of the baby before and after feeding, the feed time, the feed date, the total duration of the feed and the duration of the feed per side, and which side the mother fed (left or right), as well as the baby's weight not related to feeding, and combinations thereof. The weight of the baby can then be used to determine how much milk the baby drank during the feeding session with an algorithm. All data can be stored on the smart nursing pillow 10 and synced automatically with a mobile application (“app”) 100 on a smartphone, tablet, or computer through telemetry (BLUETOOTH®, WI-FI, or other mechanisms). The data can either be analyzed on the smart nursing pillow 10 and be stored thereon or be sent to the app 100 for analysis and storage. If the smart nursing pillow 10 does not store the data itself for later transmission to the app 100, the app 100 can record all data collected while using the smart nursing pillow 10 if the smartphone or other device is within transmission distance.

The app 100 can include a log of all feeding related activity, including the time the baby ate, side(s) fed on, duration of feed per side (i.e. the length the baby ate for on the left side, the length the baby ate for on the right side), and how much the baby drank every feeding session if the weighing function is utilized. The app 100 can quickly and easily inform the user how long it has been since the baby ate last and which breast side the baby fed from at the last feeding. The user can categorize on the app 100 whether the baby breastfed on the pillow or bottle-fed. The app 100 includes a log for tracking the baby's weight gain over time (such as first year of life), with comparison to general weight percentiles. The app 100 allows for easy tracking of infant metrics and analyzes data collected, highlights the day at a glance, spots trends quickly with easy-to-read charts, and syncs across all platforms and smartphones for easy sharing with family members or care givers. The app 100 can include a log tracking “true baby weight” (i.e., weight taken not during a feeding session, while the baby is in only a diaper) logged over time with percentile information and graphs/charts. The log of all the baby weight measurements allows the caretaker to see the baby's growth and general statistics around the baby's weight-including but not restricted to percentiles, other items/mammals weighing the same as the baby, etc. (for example: “Your baby now weighs the same as a baby seal!”). The app 100 can include a telehealth component in which the infant health and feeding data are shared safely with a medical provider (nurse or pediatrician or other). The app 100 can include the ability for the user to connect directly with a medical provider through the app 100 to help support and troubleshoot the mom in her breastfeeding journey with the help of the data recorded from the smart pillow and logged on the app 100.

The app 100 can include the ability to record bottle feeding sessions, and to assign a caretaker to a bottle-feeding session. The app 100 can include the ability to have multiple caretakers logging into the app 100. The app 100 can include the ability to record a feeding in the app 100, for when baby is being fed in a location without the smart nursing pillow 10. This includes sides being fed on.

The app 100 can include a rigorous on-boarding function to educate the parents on how to utilize the smart nursing pillow 10.

The app 100 can include data sharing capabilities with healthcare professionals and caretakers so that the app 100 can be in electronic communication with software at a physician's office for a nurse, doctor, or lactation consultant to review, or with a caretaker. Data can trigger alerts with an alert module on the mobile application 100 for the parent to call the physician's office or on the physician software for the nurse or doctor to contact the parents regarding any problems/issues. The app 100 can include a concierge professional network, connecting parents to field professionals (lactation consultants, nurses, pediatricians etc.) for telehealth or in-person appointment scheduling.

The app 100 can include general information and tips related to breastfeeding.

The app 100 can include a feed predictor, which is an algorithm that measures the baby's unique feeding pattern over times and creates a personalized feeding schedule for the baby based on the baby's own feeding history. This can be particularly helpful for babies whose breastfeeding moms are beginning to go into work, to formulate a schedule for secondary caretaker.

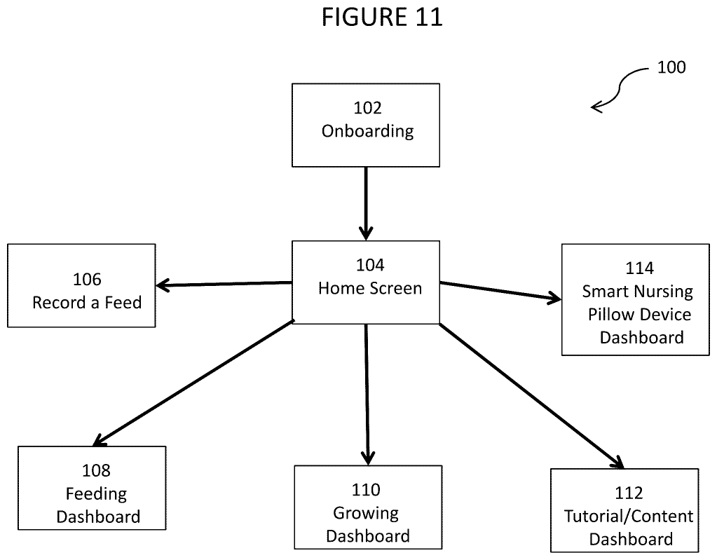

FIG. 11 shows a flowchart of information and screens found in the app 100. At an onboarding module screen 102, a user (not shown) can create a profile (signing up with their phone number or email address, Auths OTP, passcode creation, user creation in DB), log in, fill in caregiver details (full name of caregiver and avatar, ability to add additional caregivers and avatar, code share to quickly onboard additional caregivers, primary user can control additional caregiver accounts), fill in baby details (full name, nickname and avatar, weight at birth, length at birth, gender assigned at birth, due date, birth date), access terms and contracts, privacy policy and other pages (user can sign contract), and onboarding education for first use of the pillow (guiding the user for the initial charging of the pillow, guiding the user on initial BLUETOOTH® connection to smart nursing pillow 10, live prompting through different methods of using the pillow (prompt through basic feed, prompt through weighted feed and providing notice that for 100% accuracy, weight should be taken on flat surface, prompt through basic weight), quick tips, and visual tutorial of different functions in the app 100).

At a home screen module 104, quick stats can be provided so that the user can see quick relative stats. This includes but is not limited to: time baby last fed, amount of time since baby's last feed, oz baby ate at last weighted feed, side baby started nursing on last feed, side baby ended nursing on last feed, total time baby has spent eating in the last 24 hours, bottle versus breast breakdown over last 24 hours, and option to log any weight taken as “real weight” (as opposed to weight recorded for weighted feed). The quick stats can be compiled from data from the smart pillow 10 or data that is manually entered by the user. The home screen 104 provides access to additional screens/modules (Record a Feed module 106, Feeding Dashboard 108, Growing Dashboard 110, Tutorial/Content Dashboard 112, and Smart Nursing Pillow Device Dashboard 114), and the user can click on a button or widget to go to each of these screens.

At the Record a Feed module screen 106, the user can choose to manually enter a breastfeeding session that took place in the past (the user can input details such as time baby was fed, sides baby fed from, duration of feeding (per side), and oz baby drank). The user can manually enter a bottle-feeding session that took place in the past (the user can input details such as time baby was fed, duration of feeding, oz baby drank, breastmilk versus formula, and formula brand). The user can choose to record a breastfeeding session from a smartphone (this screen can mirror the buttons on the smart nursing pillow 10 in some fashion, with an L and R and a timer related to each side to record side and time in real time). The user can choose to record a bottle-feeding session from the phone (the user can use timer to time feed and the user can also input details such as oz baby drank, breastmilk versus formula, and formula brand.

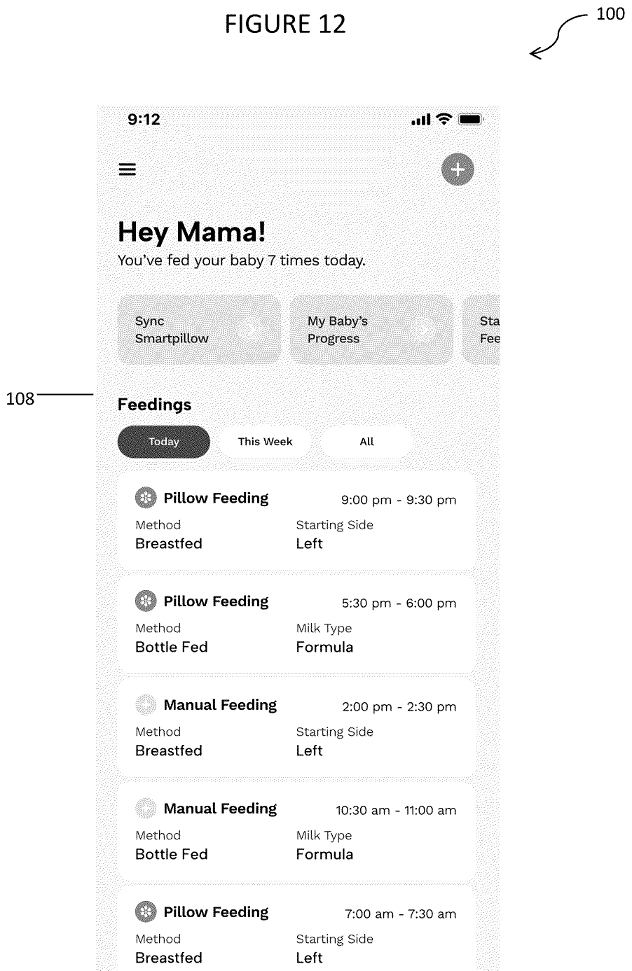

At the Feeding Dashboard screen 108, a feeding log can be accessed, and for every feeding the user can see bottle versus breast, time feeding began, duration of feeding, sides fed on and duration per side (if breastfeeding), oz drank (if available), breastmilk or formula (for bottle feeding), formula brand (for bottle feeding), option to log a weight taken as a “true weight” (it will then shift to the Growing Dashboard 110), and option to see feeding “target” based on age and weight and if baby ate enough. A summary dashboard can be provided that can include average number of feedings per day, average time between feeding, and average time baby spends feeding, per breast. A feeding statistics dashboard can be provided that can include “cute” date, i.e., time spent at the breast=amount of hours it takes to fly around the world, 100 times or baby has drunk the equivalent to half a standard size swimming pool since birth, etc., and bell curves on baby feeding times, with the user's baby stat, bell curves on baby feeding amounts, with user's baby stat. The feeding log can be populated with data taken from the nursing pillow 10 and/or from the data manually entered in on the Record a Feeding Module screen 108. An example of the Feeding Dashboard screen 108 is shown in FIG. 12, listing a log of feedings.

At the Growing Dashboard screen 110, the user can choose to manually enter a weight on the smartphone (weight, time and date taken, and optionally baby length) or sync weight related data from the smart nursing pillow 10. A weight log can be provided that can include log of “true” baby weight recorded on the smart nursing pillow 10, and a log of baby length recorded by caretaker. A weight statistics dashboard can be provided and include weight percentile data, with the baby's stats plotted over time, length percentile data, with the baby's stats plotted over time, BMI percentile data, with the baby's stats plotted over time and “cute” data, i.e., baby is now the size of a newborn dolphin. The weight log can include weight related data taken from the smart nursing pillow 10 or manually entered by the user.

At the Tutorial/Content Dashboard screen 112, a Feeding FAQs Widget can provide a comprehensive list of breastfeeding questions and answers. Video content can provide a library of tutorial and tip videos from lactation consultants.

At the Smart Nursing Pillow Device Dashboard screen 114, a pillow details dashboard can include battery level, reset option, and technology and material details. An onboarding click through can allow a user to always access the onboard clickthrough that they were prompted through at first use. A troubleshooting FAQ can provide a comprehensive list of troubleshooting frequently asked questions, along with an email and number to call for lasting issues. The Smart Nursing Pillow Device Dashboard screen 114 can also allow the user to manually sync the smart nursing pillow 10 with the app 100.

The present invention provides for a method of using the app 100, by a user accessing the onboarding module 102 and creating a profile and adding baby details, accessing a home screen module 104 and reviewing quick stats, accessing a Record a Feed module 106 and entering or recording a feed, accessing a Feeding Dashboard 108 and accessing a feeding log, accessing a Growing Dashboard 110 and accessing a weight log, accessing a Tutorial/Content Dashboard 112 for questions and answers, and accessing a Smart Nursing Pillow Device Dashboard 114 and reviewing smart nursing pillow device 10 details. Any of the additional details and steps described above can be included in this method.

While the description refers to a human baby, the smart nursing pillow 10 can also be used with animals in veterinary situations, such as confirming how much food an animal has eaten. The smart nursing pillow 10 can also be configured for other applications, such as weighing patients in a hospital bed at home or in a medical center or embedded in other surfaces as needed. Therefore, the present invention also provides for a scale 12 for weighing an individual, including a top rigid platform 14 and a bottom rigid platform 24 surrounding the scale 12 such that an air gap 20 is provided between a bottom side 22 of the scale 12 and the bottom rigid platform 24, and a top pillow portion 18 operatively attached to the top rigid platform 14. The top pillow portion 18 can be part of a bed, and the individual can lay or sit on the bed to be weighed. Any of the other features described above can also be present in this embodiment.

The present invention provides for a method of using the smart nursing pillow 10, by placing a baby on the top pillow portion 18, weighing the baby before a feeding session with the scale 12, feeding the baby, and weighing the baby after the feeding session with the scale 12. The method can further include turning on the smart nursing pillow 10 before the feeding session and reviewing data on the display panel 48. The last feed time can be displayed (i.e “Baby's last feeding started 2 hours and 32 minutes ago”), total duration of last feed time, there can be an indication of which side to start feeding (if the mother started nursing last session on her left side the display panel 48 can indicate the right breast 60 button to remind the mother that she is up to starting on the right side), what side was fed on last, the duration of the last feed preside, and combinations thereof. The baby can be weighed by pressing a scale button (not shown) on display panel 48, and the display panel 48 can provide a message to level the smart nursing pillow 10 if unbalanced. The weight of the baby can be captured by pressing the scale button, and the mother or other user removes their hands so as not to add extra weight. If breastfeeding, the mother can press either the right breast 60 or left breast 52 buttons to start feeding on one side. The time of feeding is captured, and the mother can press stop to stop that side. The opposite breast button can be pressed, the time of feeding is captured, and stop is pressed to stop that side. Either side can be repeated, as necessary. After the feeding session, the display panel 48 can show the feed times for each breast side. The weight of the baby can be captured again after feeding (or at any time during the feeding if desired) by pressing the scale button, and a message to level the smart nursing pillow 10 can be provided if necessary. The method can further include attaching the smart nursing pillow 10 to the mother with the back strap 46. Alternatively, the smart nursing pillow 10 can be placed in the mother's lap without the back strap 46 or placed on any level surface for mor stability and more accurate weighing (such as a caregiver's lap, table, floor, or changing table.

The method can further include the step of collecting data including the feed time, the feed date, the duration of the feed per side, which side the mother fed (left or right), the total duration of the feeding session from start to finish, and combinations thereof. The data can also include time fed on each breast as well as total elapsed feeding time. The weight of the baby can be calculated by subtracting the first weight before the feeding session from the second weight after the feeding session to determine how much the baby drank. The method can further include the step of sending the collected data to the app 100 and reviewing the data on a smartphone or other device. The method can further include sending the data to a physician's office software. The method can further include triggering an alert on the app 100 or the physician's office software.

The method can also be used to weigh the baby without any feeding steps. Therefore, the present invention provides for a method of weighing a baby, by placing the baby on the smart nursing pillow 10 and weighing the baby.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A smart nursing pillow, comprising a scale embedded within a top rigid platform and a bottom rigid platform such that an air gap is provided between a bottom side of said scale and said bottom rigid platform, wherein a top pillow portion is operatively attached to said top rigid platform.

2. The smart nursing pillow of claim 1, wherein said smart nursing pillow is in a shape chosen from the group consisting of C shape, rectangle, square, and circle.

3. The smart nursing pillow of claim 1, wherein said air gap ensures that only weight above said top rigid platform is measured.

4. The smart nursing pillow of claim 1, wherein said scale includes feet having sensors that detect weight.

5. The smart nursing pillow of claim 1, wherein said scale zeros out weight of said top pillow portion.

6. The smart nursing pillow of claim 1, wherein said top rigid platform and said bottom rigid platform are made of a material chosen from the group consisting of hard plastic, metal, glass, and combinations thereof.

7. The smart nursing pillow of claim 1, wherein said top pillow portion is made of a material chosen from the group consisting of soft synthetic materials, down/feather, Styrofoam, ethylene-vinyl acetate (EVA), synthetic cotton, and cotton.

8. The smart nursing pillow of claim 1, wherein said top pillow portion has a concave shape.

9. The smart nursing pillow of claim 1, wherein said bottom rigid platform includes a bottom pillow portion operatively attached thereto.

10. The smart nursing pillow of claim 9, wherein said bottom pillow portion is made of a material chosen from the group consisting of soft synthetic materials, down/feather, Styrofoam, ethylene-vinyl acetate (EVA), synthetic cotton, and cotton.

11. The smart nursing pillow of claim 9, wherein said top pillow portion is firmer than said bottom pillow portion.

12. The smart nursing pillow of claim 9, wherein said bottom pillow portion includes a flat bottom surface.

13. The smart nursing pillow of claim 9, wherein said smart nursing pillow includes an infant insert removably attached to said bottom pillow portion.

14. The smart nursing pillow of claim 1, wherein said smart nursing pillow includes an outer cover.

15. The smart nursing pillow of claim 14, wherein said outer cover includes at least one pocket.

16. The smart nursing pillow of claim 1, wherein said smart nursing pillow includes an illumination mechanism.

17. The smart nursing pillow of claim 16, wherein said illumination mechanism is viewable through said outer cover.

18. The smart nursing pillow of claim 16, wherein said illumination mechanism includes dimming control.

19. The smart nursing pillow of claim 1, wherein said smart nursing pillow includes a back strap removably attached thereto through a strap attachment.

20. The smart nursing pillow of claim 19, wherein said strap attachment includes an attachment mechanism chosen from the group consisting of releasable buckles and hook and loop.

21. The smart nursing pillow of claim 1, wherein said smart nursing pillow includes a battery, hardware for BLUETOOTH®, BLE module, infrared (IR) transmitter, WI-FI, computer storage, circuits, weight measurement system, strain gauge and Wheatstone bridge system, and a display panel.

22. The smart nursing pillow of claim 21, wherein said display panel is located on a front side of said top pillow portion.

23. The smart nursing pillow of claim 21, wherein said display panel is a mode chosen from the group consisting of analog and digital.

24. The smart nursing pillow of claim 21, wherein said display panel includes indicators for left breast, syncing, OK, battery status, right breast, stop, and scale.

25. The smart nursing pillow of claim 21, wherein said display panel includes a timer.

26. The smart nursing pillow of claim 21, wherein said display panel shows weight before an individual is fed and weight at any increment of time during a feeding.

27. The smart nursing pillow of claim 21, wherein said display panel shows how long it has been since the individual last fed.

28. The smart nursing pillow of claim 21, wherein said display panel shows which side a mother finished feeding on at her last feeding session.

29. The smart nursing pillow of claim 1, wherein said smart nursing pillow collects, and measures information on non-transitory computer readable media during use including weight of the individual before and after feeding, feed time, feed date, duration of the feed, which side the mother fed, and individual's weight not related to feeding.

30. The smart nursing pillow of claim 1, wherein said smart nursing pillow determines how much the individual drank during a feeding session.

31. The smart nursing pillow of claim 1, wherein said smart nursing pillow is capable of syncing any data to a mobile application stored on non-transitory computer readable memory.

32. The smart nursing pillow of claim 1, wherein said smart nursing pillow is used with an individual chosen from the group consisting of an animal and human baby.

33. A mobile application for use with the smart nursing pillow of claim 1, comprising an onboarding module, a home screen module, a Record a Feed module, a Feeding Dashboard, a Growing Dashboard, a Tutorial/Content Dashboard, and a Smart Nursing Pillow Device Dashboard stored on non-transitory computer readable media.

34. The mobile application of claim 33, wherein said mobile application includes a log of all feeding activity of the time the individual ate, side(s) fed on, duration of feed per side, and how much the individual drank every feeding session.

35. The mobile application of claim 33, wherein said mobile application includes a log of tracking weight gain over time with comparison to general weight percentiles.

36. The mobile application of claim 33, wherein said mobile application records bottle feeding sessions.

37. The mobile application of claim 33, wherein said mobile application allows for multiple caregivers to log in.

38. The mobile application of claim 33, wherein said mobile application includes data sharing with healthcare professionals.

39. The mobile application of claim 33, wherein said mobile application includes an alert module triggered by data.

40. The mobile application of claim 33, wherein said mobile application includes a feed predictor and creates a personalized feeding schedule for an individual.

41. The mobile application of claim 33, wherein said onboarding module includes a user profile, log in information, caregiver details, baby details, access terms and contracts, privacy policy, and onboarding education for first use.

42. The mobile application of claim 33, wherein said home screen module includes quick stats of time last fed, amount of time since last feed, oz ate at last weighted feed, side started nursing on last feed, side ended nursing on last feed, total time spent eating in the last 24 hours, bottle versus breast breakdown over last 24 hours, and log any weight taken as “real weight”.

43. The mobile application of claim 42, wherein said home screen module provides access to said Record a Feed module, Feeding Dashboard, Growing Dashboard, Tutorial/Content Dashboard, and Smart Nursing Pillow Device Dashboard.

44. The mobile application of claim 33, wherein said Record a Feed module allows for a user to manually enter a breastfeeding session that took place in the past, manually enter a bottle feeding session that took place in the past, record a breastfeeding session from a smartphone, and record a bottle feeding session from a smartphone.

45. The mobile application of claim 33, wherein said Feeding Dashboard allows a user to access a feeding log, a summary dashboard including average number of feedings per day, average time between feeding, and average time baby spends feeding, per breast, and a feeding statistics dashboard displaying data.

46. The mobile application of claim 33, wherein said Growing Dashboard allows a user to manually enter a weight on a smartphone, access a weight log, and a weight statistics dashboard.

47. The mobile application of claim 33, wherein said Tutorial/Content Dashboard provides a list of breastfeeding questions and answers.

48. The mobile application of claim 33, wherein said Smart Nursing Pillow Device Dashboard includes battery level, reset option, technology and material details, and troubleshooting.

49. A method of using an application with the smart nursing pillow of claim 1, including the steps of a user:
accessing the onboarding module and creating a profile and adding individual details;
accessing a home screen module and reviewing quick stats;
accessing a Record a Feed module and entering or recording a feed;
accessing a Feeding Dashboard and accessing a feeding log;
accessing a Growing Dashboard and accessing a weight log;
accessing a Tutorial/Content Dashboard for questions and answers; and
accessing a Smart Nursing Pillow Device Dashboard and reviewing smart nursing pillow device details.

50. A method of using a smart nursing pillow, including the steps of:
placing an individual on a top pillow portion of the smart nursing pillow, wherein the smart nursing pillow includes a scale embedded within a top rigid platform and a bottom rigid platform such that an air gap is provided between a bottom side of the scale and the bottom rigid platform, wherein the top pillow portion is operatively attached to the top rigid platform;
weighing the individual before a feeding session with the scale;
feeding the individual; and
weighing the individual after the feeding session with the scale.

51. The method of claim 50, wherein the individual is chosen from the group consisting of an animal and human baby.

52. The method of claim 50, further including before said placing step, the steps of turning on the smart nursing pillow and reviewing data on a display panel.

53. The method of claim 52, wherein said data includes data chosen from the group consisting of last feed time, total duration of feeding session, an indication of which side to start feeding, what side was fed on last, duration of feed per side, and combinations thereof.

54. The method of claim 50, wherein said weighing step includes pressing a scale button on a display panel, and capturing the weight by pressing the scale button.

55. The method of claim 50, wherein said feeding step includes pressing right breast or left breast buttons to start feeding on one side, capturing the time of feeding, pressing stop to stop the side, and repeating with the opposite side breast.

56. The method of claim 50, further including the step of displaying feed times for each breast side.

57. The method of claim 50, further including the step of displaying a message to level the smart nursing pillow while weighing.

58. The method of claim 50, further including before said placing step, the step of attaching the smart nursing pillow to a mother with a back strap.

59. The method of claim 50, further including before said placing step, the step of placing the smart nursing pillow in the lap of a mother or caregiver.

60. The method of claim 50, further including before said placing step, the step of placing the smart nursing pillow on a level surface.

61. The method of claim 50, further including the step of collecting data chosen from the group consisting of the feed time, the feed date, the duration of the feed per side, and which side the mother fed, total duration of feeding session, and combinations thereof.

62. The method of claim 50, further including the step of calculating the weight of the individual by subtracting a first weight before the feeding session from a second weight after the feeding session to determine how much the individual drank.

63. The method of claim 50, further including the step of sending collected data to an application stored on non-transitory computer readable media and reviewing the data on a smartphone.

64. The method of claim 63, further including the step of sending the data to a physician's office software.

65. The method of claim 63, further including the step of triggering an alert on the application or the physician's office software.

66. A method of weighting an individual, including the steps of:
placing the individual on a smart nursing pillow, wherein the smart nursing pillow includes a scale embedded within a top rigid platform and a bottom rigid platform suck that an air gap is provided between a bottom side of the scale and the bottom rigid platform, wherein a top pillow portion is operatively attached to the top rigid platform; and
weighing the individual.

67. The method of claim 66, wherein the individual is chosen from the group consisting of an animal and a human baby.

68. A scale for weighing an individual, comprising a top rigid platform and a bottom rigid platform surrounding said scale such that an air gap is provided between a bottom side of said scale and said bottom rigid platform, and a top pillow portion operatively attached to said top rigid platform.

69. The scale of claim 68, wherein said top pillow portion is part of a bed.
